(19) United States
(12) Patent Application Publication
(10) Pub. No.: US 2008/0059556 A1
(43) Pub. Date: Mar. 6, 2008

(54) Providing virtual machine technology as an embedded layer within a processing platform

(75) Inventors: Alan Greenspan, Northborough, MA (US); Patrick J. O'Rourke, Lunenberg, MA (US); Philip R. Auld, Hudson, MA (US)

Correspondence Address: WILMERHALE/BOSTON, 60 STATE STREET, BOSTON, MA, 02109, US

(73) Assignee: Egenera, Inc.

(21) Appl. No.: 11/513,877

(22) Filed: Aug. 31, 2006

(51) Int. Cl. G06F 15/16

(52) U.S. Cl. 709/201; 709/220

(57) ABSTRACT

A platform, method, and computer program product, provides virtual machine technology within a processing platform. A computing platform automatically deploys one or more servers in response to receiving corresponding server specifications. Each server specification identifies a server application that a corresponding server should execute and defines communication network and storage network connectivity for the server. The platform includes a plurality of processor nodes and virtual machine hypervisor. The virtual machine hypervisor logic has logic for instantiating and controlling the execution of one or more guest virtual machines on a computer processor. In response to interpreting the server specification, control software deploys computer processors or guest virtual machines to execute the identified server application and automatically configures the defined communication network and storage network connectivity to the selected computer processors or guest virtual machines to thereby deploy the server defined in the server specification.

### TECHNICAL FIELD

This invention relates generally to computing systems for enterprises and application service providers and, more specifically, to systems and methods for allocating physical processing resources via software commands using Processing Area Networking technology and to systems and methods for partitioning individual processors using Virtual Machine technology.

### BACKGROUND OF THE INVENTION

Existing platforms for deploying virtual Processing Area Networks typically include a plurality of computer processors connected to an internal communication network. One or more control nodes are in communication with an external communication network, and an external storage network that has an external storage address space. The control node or nodes are connected to the internal network and are in communication with the plurality of computer processors. Driven by users' specifications of desired server systems, configuration logic defines and establishes a virtual Processing Area Network that has a corresponding set of computer processors from the plurality of processors, a virtual local area communication network providing communication among the set of computer processors, and a virtual storage space with a defined correspondence to the address space of the storage network. See, for example, U.S. Patent Publication US 2004/0236987, U.S. Patent Publication US 2004/0221150, U.S. Patent Publication US 2004/0220795, and U.S. patent application Ser. No. 10/999,118.

Such platforms provide a processing platform from which virtual systems may be deployed rapidly and easily through logical configuration commands, rather than physically assembling hardware components. Users specify the requirements of their desired virtual systems by entering definitions of them into the platform using configuration logic provided on the one or more control nodes. When a user desires to instantiate (boot) such virtual systems, deployment logic on the one or more control nodes automatically selects and configures suitable resources from the platform's large pool of processors to form a virtualized network of computers (“Processing Area Network” or “processor clusters”), without requiring hardware to be physically assembled or moved. Such virtualized networks of computers are as functional and as powerful as conventional stand-alone computers assembled manually from physical hardware, and may be deployed to serve any given set of applications or customers, such as web-based server applications for one example. The virtualization in these clusters may include virtualization of local area networks (LANs) and the virtualization of disk storage. Such platforms obviate the arduous and lengthy effort of physically installing servers, cabling power and network and storage and console connections to them, providing redundant copies of everything, and so forth.

Each processor of the pool of processors has significant processing power. This power may be underutilized. Typically such platforms group processors within discrete processing nodes, and define computing boundaries around the processing nodes. Thus, a particular function (e.g., a server) occupies a full processing node, and any surplus processing power is wasted. Thus, an additional function (e.g., a second server) is often implemented in another processing node, and cannot utilize the surplus from the first processing node.

Virtual Machine technology may be used to partition physical processors and provide finer processing granularity. Such Virtual Machine technology has existed for some time. However, in order to use this technology, the technology administrator must reconfigure the system to instantiate multiple Virtual Machines and then install operating systems and application software on each one, which is tedious, error-prone, and inflexible.

Consequently, there is a need for a system and method to automatically provision the correct amount of processing resource to any given application, whether a fraction of one physical processor, using Virtual Machine technology, or a plurality of entire processors, while obviating the inconvenience and risk of Virtual Machine installation and administration.

### SUMMARY OF THE INVENTION

The invention provides virtual machine technology within a processing platform. The invention relates to a unique method of combining Processing Area Networking technology and Virtual Machine technology.

Under one aspect of the invention, a computing platform automatically deploys one or more servers in response to receiving corresponding server specifications. Each server specification identifies a server application that a corresponding server should execute and defines communication network and storage network connectivity for the server. The platform includes a plurality of processor nodes each including at least one computer processor and physical memory, and virtual machine hypervisor logic installable and executable on a set of the processor nodes. The virtual machine hypervisor logic has logic for instantiating and controlling the execution of one or more guest virtual machines on a computer processor. Each guest virtual machine has an allocation of physical memory and of processing resources. The platform also includes control software executing on a processor for interpreting a server specification. In response to interpreting the server specification, the control software deploys computer processors or guest virtual machines to execute the identified server application and automatically configures the defined communication network and storage network connectivity to the selected computer processors or guest virtual machines to thereby deploy the server defined in the server specification.

Under another aspect of the invention, the control software includes software to automatically install and cause the execution of virtual machine hypervisor logic on a processor node in response to interpreting a server specification and selecting a guest virtual machine to satisfy requirements of the server specification.

Under another aspect of the invention, a server specification specifies a pool corresponding to designated processing nodes or guest virtual machines, and the control software includes logic to select processing nodes or guest virtual machines from the specified pool to satisfy requirements of the server specification.

Under another aspect of the invention, the server specification is independent of the virtual machine hypervisor logic.

Under another aspect of the invention, the platform includes multiple versions of virtual machine hypervisor logic, and the control software can cause the installation and simultaneous execution of a plurality of different versions of the virtual machine hypervisor logic to satisfy a plurality of server specifications.

Under another aspect of the invention, the control software includes logic to migrate the deployment of a server from a first set of computer processors or guest virtual machines to a second set of computer processors or guest virtual machines.

Under another aspect of the invention, the servers deployed on the platform are suspendable, and the control software includes logic to retain execution states of suspended servers on persisted storage separate from any instance of virtual machine hypervisor logic, so that such suspended states may be resumed by other instances of virtual machine hypervisor logic.

### BRIEF DESCRIPTION OF DRAWINGS

In the drawing,

FIG. 1 is a system diagram illustrating one embodiment of the invention;

FIGS. 2A-C are diagrams illustrating the communication links established according to one embodiment of the invention; and

FIG. 3 shows one embodiment of Virtual Machines implemented on a physical processing node 105 according to the invention.

### DESCRIPTION OF THE PREFERRED EMBODIMENTS

Preferred embodiments of the invention deploy virtual Processing Area Networks, in which the virtual Processing Area Networks can have either or both physical (entire processors) and Virtual Machine (fractions of processors) processing resources. The underlying Processing Area Networking architecture for this embodiment is described, for example, in U.S. Patent Publication US 2003/0130833, which is hereby incorporated herein by reference in its entirety. Specific uses of this architecture are disclosed in, for example, U.S. Patent Publication US 2004/0236987, U.S. Patent Publication US 2004/0221150, U.S. Patent Publication US 2004/0220795, and U.S. patent application Ser. No. 10/999,118, all of which are hereby incorporated herein by reference in their entirety.

Embodiments of the invention provide a system and method that automatically establish Virtual Machines on one or more of the physical processing nodes within a Processing Area Network platform, when needed to correctly size the virtual processing system to run an application, without requiring the skill or attention of a human administrator.

### Overview of an Exemplary Configurable Platform for Deploying Processing Area Networks

Certain embodiments utilize configurable platforms for deploying Processing Area Networks. Preferably these platforms are like those described in the incorporated U.S. patent applications and/or like Egenera's “BladeFrame” platform.

In short, the platforms provide a collection of resources that may be allocated and configured to emulate independent Processing Area Networks in response to software commands. The commands, for example, may or may not describe the number of processing nodes that should be allocated to execute the server application. The commands typically describe the network connectivity, the storage personality, and the like for the Processing Area Network. The various networking, cabling, power, and so on are effectively emulated, and thus permit rapid instantiation of the processing network (as opposed to the complicated and slow physical deployment in conventional approaches).

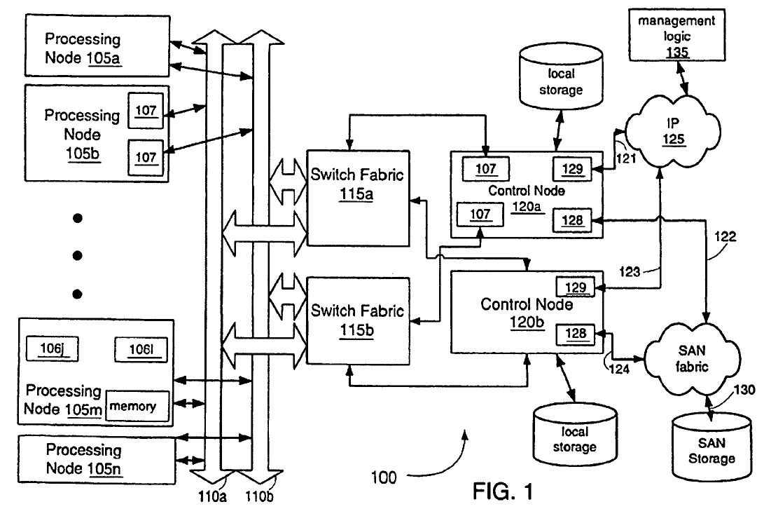

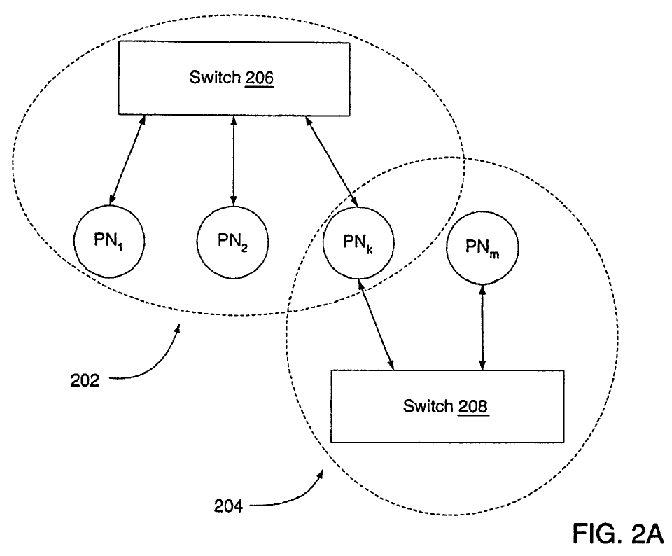

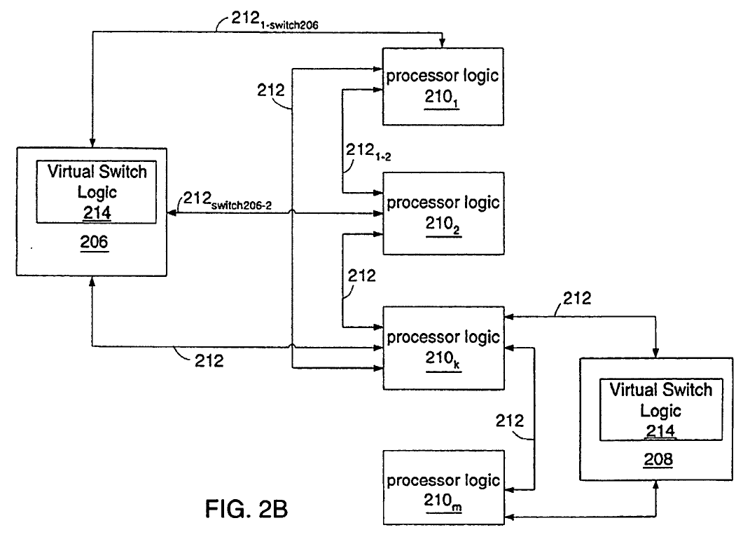

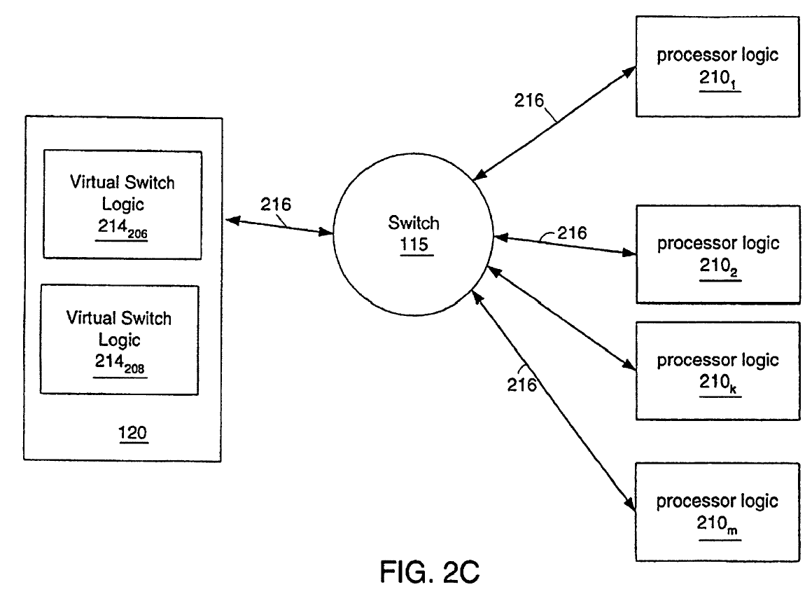

FIG. 1 depicts an exemplary platform for the described embodiments of the invention. As outlined below and described in more detail in the incorporated patent applications, preferred platforms provide a system, method and logic through which virtual systems may be deployed through configuration commands. The platform provides a large pool of processors from which a subset may be selected and configured through software commands to form a virtualized network of computers (“Processing Area Network” or “processor clusters”) that may be deployed to serve a given set of applications or customer. The virtualized Processing Area Network may then be used to execute arbitrary customer applications, just as conventionally assembled hardware could, such as web-based server applications for example. FIGS. 2A-C show an exemplary Processing Area Network. This Processing Area Network could be used to execute a tiered web-based application, for example. The virtualization may include virtualization of local area networks (LANs) or the virtualization of disk storage. By providing such a platform, processing resources may be deployed rapidly and easily through software via configuration commands, e.g., from an administrator, rather than through physically assembling servers, cabling network and storage connections, providing power to each server, and so forth.

As shown in FIG. 1, a preferred hardware platform 100 includes a set of processing nodes 105a-n connected to a switch fabrics 115a,b via high-speed, interconnect 110a,b. The switch fabric 115a,b is also connected to at least one control node 120a,b that is in communication with an external IP (Internet Protocol) network 125 (or other data communication network) providing communication outside the platform, and with a storage area network (SAN) 130 providing disk storage for the platform to use. A management application 135, for example, executing remotely, may access one or more of the control nodes via the IP network 125 to assist in configuring the platform 100 and deploying virtualized Processing Area Networks.

Under certain embodiments, about 24 processing nodes 105a-n, two control nodes 120, and two switch fabrics 115a,b are contained in a single chassis and interconnected with a fixed, pre-wired mesh of point-to-point links. Each processing node 105 is a board that includes one or more (e.g., 4) processors 106j-l, one or more network interface cards (NICs) 107, and local memory (e.g., greater than 4 Gbytes) that, among other things, includes some BIOS (basic input/output system) firmware for booting and initialization. There are no local disks for the processing nodes 106; instead, SAN storage devices 130 handle all disk storage, including that needed for paging, for the processing nodes.

Each control node 120 is a single board that includes one or more (e.g., 4) processors, local memory, local disk storage for holding a bootable copy of the software that runs on said control node, said software implementing the logic to control and manage the entire platform 100, and removable media optical readers (not shown, such as compact disk (CD) readers or digital versatile disk (DVD) readers) from which new software can be installed into the platform. Each control node communicates with SAN 130 via 100-megabyte/second fibre-channel adapter cards 128 connected to fibre-channel links 122, 124 and communicates with the Internet (or any other external network) 125 via an external network interface 129 having one or more Gigabit Ethernet NICs connected to Gigabit Ethernet links 121,123. Many other techniques and hardware may be used for SAN and external network connectivity. Each control node includes a low speed Ethernet port (not shown) as a dedicated management port, which may be used instead of or in addition to remote, web-based management via management application 135.

The switch fabric is composed of one or more 30-port Giganet switches 115, such as the NIC-CLAN 1000 and CLAN 5300 switches, and the various processing and control nodes use corresponding NICs for communication with such a fabric module. Giganet switch fabrics have the semantics of a Non-Broadcast Multiple Access (NBMA) network. All inter-node communication is via a switch fabric. Each link is formed as a serial connection between a NIC 107 and a port in the switch fabric 115. Each link operates at 112 megabytes/second. In other embodiments, other switching technology may be utilized, for example, conventional Ethernet switching.

In some embodiments, multiple cabinets or chassis may be connected together to form larger platforms. And in other embodiments the configuration may differ; for example, redundant connections, switches and control nodes may be eliminated.

Under software control, the platform supports multiple, simultaneous and independent Processing Area Networks. Each Processing Area Network, through software commands, is configured to have a corresponding subset of processors 106 that may communicate via a virtual local area network that is emulated over the switch fabric 115. Each Processing Area Network is also configured to have a corresponding virtual disk subsystem that is emulated over the point-to-point mesh, through the control nodes 120, and out to the SAN storage fabric 130. No physical deployment or cabling is needed to establish a Processing Area Network. When a specific processing node 105 is chosen by control logic to deploy a virtual server, control logic programs the specific communication paths through the switch fabric 115 that permit that deployment of the virtual server to have the network connectivity to other servers executing on other processing nodes 105 or to the external IP network 125 that its virtual definition specifies, and to have the connectivity through the one or more control nodes 120 to the specific disks of the external disk storage 130 that its virtual definition specifies. Under certain preferred embodiments, software logic executing on the processor nodes and/or the control nodes emulates switched Ethernet semantics.

Certain embodiments allow an administrator to build virtual, emulated LANs using virtual components, interfaces, and connections. Each of the virtual LANs can be internal and private to the platform 100, or the virtual LAN may be connected to the external IP network 125, through the control nodes 120 and external links 121,123. Also multiple processors may be formed into a processor cluster externally visible as a single IP address.

Under certain embodiments, the virtual networks so created emulate a switched Ethernet network, though the physical, underlying network may be a point-to-point mesh. The virtual network utilizes Media Access Control (MAC) addresses as specified by the Institute of Electrical and Electronic Engineers (IEEE), and the processing nodes support Address Resolution Protocol (ARP) processing as specified by the Internet Engineering Task Force (IETF) to identify and associate IP (Internet Protocol) addresses with MAC addresses. Consequently, a given processor node replies to an ARP request consistently whether the ARP request came from a node internal or external to the platform.

The software commands from which Processing Area Networks are configured take the form of definitions for the virtual servers within it, such definitions being created by users or administrators of the platform and then stored on the local disks of the one or more control nodes 120. A virtual server is defined with various attributes that allow it operate in the same manner as an equivalent physical server once instantiated by the control software. Virtual server attributes may define the server's processor and memory requirements. These may be expressed as the identifications of specific processing nodes that meet the server's requirements; they may be expressed as identifications of pools populated by various suitable specific processing nodes; or they may be expressed parametrically as minimum and maximum limits for the number of processors, processor clock speeds, or memory size needed by the virtual server. Virtualized firmware attributes for servers may define boot parameters such as boot device ordering, network booting addresses, and authentication data or they may contain settings that affect application performance such as hyperthreading enablement, memory interleaving, or hardware prefetch. Server device connectivity attributes may be defined for virtual NIC devices and may include MAC addresses, networking rate limits, and optional connectivity to virtual network switches. Storage attributes may include definitions of virtual disk devices and the mapping of such devices to reachable SAN disks, storage locally attached to the one or more control nodes 120, or files that act as disk devices if provided by the control software. Other attributes may include virtual CD-ROM definitions that map virtual server CD-ROM devices to real CD-ROM devices or to ISO CD-ROM image files managed by the control software.

FIG. 2A shows an exemplary network arrangement that may be modeled or emulated. Processing nodes PN.sub.1, PN.sub.2, and PN.sub.k form a first subnet 202 that may communicate with one another via emulated switch 206. Processing nodes PN.sub.k and PN.sub.m form a second subnet 204 that may communicate with one another via emulated switch 208. Under switched Ethernet semantics, one node on a subnet may communicate directly with another node on the subnet; for example, PN.sub.1 may send a message to PN.sub.2. The semantics also allow one node to communicate with a set of the other nodes; for example PN.sub.1 may send a broadcast message to other nodes. The processing nodes PN.sub.1 and PN.sub.2 cannot directly communicate with PN.sub.m because PN.sub.m is on a different subnet. For PN.sub.1 and PN.sub.2 to communicate with PN.sub.m higher layer networking software would need to be utilized, which software would have a fuller understanding of both subnets. Though not shown in the figure, a given switch may communicate via an uplink to another switch or an external IP network. As will be appreciated given the description below, the need for such uplinks is different than their need when the switches are physical. Specifically, since the switches are virtual and modeled in software, they may scale horizontally to interconnect as many processing nodes as needed. (In contrast, physical switches have a fixed number of physical ports, and sometimes uplinks to further switches with additional ports are needed to provide horizontal scalability.)

FIG. 2B shows exemplary software communication paths and logic used under certain embodiments to model the subnets 202 and 204 of FIG. 2A. The point-to-point communication paths 212 connect processing nodes PN.sub.1, PN.sub.2, PN.sub.k, and PN.sub.m, specifically their corresponding processor-side network communication logic 210, and they also connect processing nodes to control nodes. (Though drawn as a single instance of logic for the purpose of clarity, PN.sub.k may have multiple instances of the corresponding processor logic, one per subnet, for example.) Under preferred embodiments, management logic and the control node logic are responsible for establishing, managing and destroying the communication paths, which are programmed into the switching fabric. For reasons of security, the individual processing nodes are not permitted to establish such paths, just as conventional physical computers are unable to reach outside themselves, unplug their network cables, and plug them in somewhere else.

As will be explained in detail below, the processor logic and the control node logic together emulate switched Ethernet semantics over such communication paths. For example, the control nodes have control node-side virtual switch logic 214 to emulate some (but not necessarily all) of the semantics of an Ethernet switch, and the processor logic includes logic to emulate some (but not necessarily all) of the semantics of an Ethernet driver.

Within a subnet, one processor node may communicate directly with another via a corresponding point-to-point communication path 212. Likewise, a processor node may communicate with the control node logic via another point-to-point communication path 212. Under certain embodiments, the underlying switch fabric and associated control logic executing on control nodes provide the ability to establish and manage such communication paths over the point-to-point switch fabric. Moreover, these communication paths may be established in pairs or multiples, for increased bandwidth and reliability.

Referring conjointly to FIGS. 2A-B, if node PN.sub.1 is to communicate with node PN.sub.2 it does so ordinarily by communication path 212.sub.1-2. However, preferred embodiments allow communication between PN.sub.1 and PN.sub.2 to occur via switch emulation logic as well. If PN.sub.1 is to broadcast or multicast a message to other nodes in the subnet 202, it may do so by cloning or replicating the message and sending it to each other node in the subnet individually. Alternately, it may do so by sending a single message to control node-side logic 214. Control node-side logic 214 then emulates the broadcast or multicast functionality by cloning and sending the message to the other relevant nodes using the relevant communication paths. The same or analogous communication paths may be used to convey other messages requiring control node-side logic. For example, as will be described below, control node-side logic includes logic to support the Address Resolution Protocol (ARP), and communication paths are used to communicate ARP replies and requests to the control node. Though the above description suggests just one communication path between processor logic and control logic, many embodiments employ several such connections for increased bandwidth and availability. Moreover, though the figures suggest symmetry in the software communication paths, the architecture actually allows asymmetric communication. For example, as will be discussed below, for communication to clustered services the packets would be routed via the control node. However, return communication may be direct between nodes.

Notice that like the network of FIG. 2A, there is no mechanism for communication between node PN.sub.2, and PN.sub.m. Moreover, by having communication paths managed and created centrally (instead of via the processing nodes) such a path is not creatable by the processing nodes, and a processor cannot violate the defined subnet connectivity.

FIG. 2C shows the exemplary physical connections of certain embodiments to realize the subnets of FIGS. 2A and B. Specifically, each instance of processing network logic 210 communicates with the switch fabric 115 via a point-to-point link 216 of interconnect 110. Likewise, the control node has multiple instances of switch logic 214 and each communicates over a point-to-point connection 216 to the switch fabric. The communication paths of FIG. 2B include the logic to convey information over these physical links, as will be described further below.

To create and configure such networks, an administrator defines the network topology of a Processing Area Network and specifies (e.g., via a utility within the management software 135) MAC address assignments of the various nodes. The MAC address is virtual, identifying a communication path to a specified virtual server, and is not tied to any of the various physical nodes on which that server may from time to time be deployed. Under certain embodiments, MAC addresses follow the IEEE 48-bit address format, but in which the contents include a “locally administered” bit set to 1, the serial number of the control node 120 on which the communication path was originally defined (more below), and a count value from a persistent sequence counter on the control node that is kept in non-volatile memory in the control node to ensure that all such addresses are unique and do not duplicate each other. These MACs will be used to identify the nodes (as is conventional) at a networking layer 2 level. For example, in replying to ARP requests (whether from a node internal to the Processing Area Network or on an external network) these MACs will be included in the ARP reply.

The control node-side networking logic maintains data structures that contain information reflecting the connectivity of the LAN (e.g., which nodes may communicate to which other nodes). The control node logic also allocates and assigns communication paths mapping to the defined MAC addresses and allocates and assigns communication paths between the control nodes and between the control nodes and the processing nodes. In the example of FIG. 2A, the logic would allocate and assign communication paths 212 of FIG. 2B. (The naming of the communication paths in some embodiments is a consequence of the switching fabric and the switch fabric manager logic employed.)

As each processor boots, BIOS-based boot logic initializes each processor 106 of the node 105 and, among other things, discovers the communication path 212 to the control node logic. The processor node then obtains from the control node relevant data link information, such as the processor node's MAC address, and the MAC identities of other devices within the same data link configuration. Each processor then registers its IP address with the control node, which then binds the IP address to the node and a communication path (e.g., the communication path on which the registration arrived). In this fashion, the control node will be able to bind IP addresses for each virtual MAC for each node on a subnet. In addition to the above, the processor node also obtains the communication path-related information for its connections to other nodes or to control node networking logic. Thus, after BIOS-based boot logic, the various processor nodes understand their networking layer 2, or data link, connectivity. As will be explained below, layer 3 (IP) connectivity and specifically layer 3 to layer 2 associations are determined during normal processing of the processors as a consequence of the IETF Address Resolution Protocol (ARP) which is a normal part of any operating system running on the nodes.

After BIOS-based boot logic has established layer 2 network connectivity with the platform's one or more control nodes, the processor node proceeds with its operating system boot. As on conventional processors, this can be a network boot or a disk boot. The user who creates the definition of the virtual server to run on this node makes the choice; that is, the way in which the virtual server boots is a property of the virtual server, stored in its definition on the one or more control nodes, not a property of the processor node chosen to run it. Just as the BIOS-based boot logic learns its network connectivity from the one or more control nodes, it learns the choice of boot method from the one or more control nodes. If the network boot method has been chosen in this virtual server's definition, then the BIOS-based boot logic performs a network boot in the normal way by broadcasting a message on its virtualized network connections to locate a boot image server. Logic on the one or more control nodes responds to this message, and supplies the correct boot image for this virtual server, according to the server's definition as stored on the one of more control nodes. Boot images for virtual servers that choose the network boot method are stored on the local disks of the one or more control nodes, alongside the definitions of the servers themselves. Alternately, if the disk boot method has been chosen in this virtual server's definition, then several embodiments are possible. In one embodiment, the BIOS logic built into the processing nodes is aware that such processing nodes have no actual disks, and that disk operations are executed remotely, by being placed in messages sent through the platform's high-speed internal communication network, through the one or more control nodes, and thence out onto the external SAN fabric where those disk operations are ultimately executed on physical disks. In this case, the BIOS boot logic performs a normal disk boot, though from a virtualized disk, and the actual disk operations will be executed remotely on the SAN disk volume which has been specified in this virtual server's definition as the boot disk volume for this virtual server. In another embodiment, the BIOS logic has no built-in awareness of how to virtualize disk operations by sending them in messages to remote disks. In this case, the BIOS boot logic, when instructed to do a disk boot, first performs a network boot anyway. In this embodiment, the boot image that is sent by the one or more control nodes in response to the network boot request is not the ultimate operating system boot image sought by the boot operation, but that of intermediate booting logic that is aware of how to virtualize disk operations by sending them in messages to remote disks. The image of this intermediate booting logic is stored on the local disks of the one or more control nodes, alongside other network boot images, so that it is available for this purpose. When this intermediate booting logic has been loaded into the processing node and given control by the BIOS boot logic, the intermediate booting logic performs the disk boot over the virtualized disks, in the same manner as if such logic had been present in the BIOS logic itself.

The operating system image loaded by the BIOS or intermediate booting logic can be any of a number of operating systems of the user's choice at the time he makes his virtual server definition. Typical operating systems are open-source Linux, Microsoft Windows, and Sun Microsystems Solaris Unix, though others are possible. The operating system image that is part of a virtual server must have been installed with device driver software that permits it to run on processing node hardware. Unlike conventional computer hardware, processing nodes have no local networking, disk, or console hardware. Consequently, networking, disk, and console devices must be virtualized for the operating system. This virtualization is done by the device driver software installed into the operating system boot image at the time that image is created (more on this creation below). The device driver software presents the illusion to the operating system that the hardware has physical networking, disk, and console functions. When the operating system initiates a networking, disk, or console operation, the device driver software places the operation into a message and sends it across the high-speed internal communication fabric to the remote point at which the operation is actually executed. Typically, loading device driver software that permits the operating system to run on processing node hardware is the only requirement on the virtual server's operating system. The operating system itself, aside from the device driver software, is identical to that which runs on any conventional computer. The operating system as well as all the applications that run on it are unaware that their processing node lacks actual networking, disk, and console hardware, because those functions are effectively simulated for it.

The next stage in the booting operation is for the operating system to initialize itself, which consists of surveying the hardware it is running on (it will see the virtualized network devices, virtualized disk devices, and virtualized console device simulated for it by the device driver software), locating its file system (which it will see on one or more of its virtualized disks), and finally launching user applications (which have been installed into its file system). Aside from occurring on virtualized devices, these steps are completely as on conventional computers. From this point on, the virtual server is up and running the user's applications in a completely normal fashion.

It should now be clear that operating systems, file systems, and application programs are installed into virtual servers, not into the processing nodes on which those virtual servers may from time to time run. Installation proceeds one way for virtual servers which are to be booted from disk, and another way for those which are to be booted from network. If a virtual server is to be booted from disk, then when such a server is created (that is, its definition is created on the one or more control nodes), any disks out in the SAN storage fabric assigned to it are blank and it has no operating system or file systems or applications. The boot device marked in its definition is one of the removable media optical readers provided on the one or more control nodes. When the virtual server is booted for the first time, the user must insert the operating system vendor's installation media into the optical reader. The virtual server will perform its disk boot from that media and execute the vendor's installation program. The vendor's installation program will create file systems on one or more of the blank SAN disks assigned to this virtual server and copy the operating system image from the optical media into the virtual server's file systems. The next time the virtual server is booted, it can do a disk boot from its own SAN disks. Alternately, if the virtual server is to be booted from network, its definition is made to point to an operating system image already residing on the one or more control nodes, such image being simply a copy of an operating system image that was once created by doing an installation from optical media as just described, such images normally coming preloaded on the one or more control nodes of the platform as they are shipped by the platform vendor. Then, control logic executing on the one or more control nodes copies a file system onto one or more of the SAN disks assigned to the virtual server, this file system being a copy of the file system constructed during an operating system installation from optical media as just described. Subsequent to the installation of the operating system and the attendant creation of a file system for the virtual server by either method above, the server is operable, and any application programs the user wishes to install on it (i.e., into its file system) can be done during normal operation of the server. That is, the server is booted, then an installation of the application software is performed, just as it would on conventional hardware. The application can be installed from optical media placed in the optical readers on the one or more control nodes, or the installation software can be downloaded from the network, as the virtual server has emulated network connectivity.

It should be appreciated that platforms other than that outlined above may be used. That is, other arrangements of configurable platforms may also be utilized though the internal architectures and capabilities may differ. For example, the preferred platform includes particular types of emulation logic in connection with its supported Processing Area Network networking functionality. Though this logic is believed to offer certain advantages, it is not necessary for the present invention.

### Implementing Virtual Machines

As described above, control nodes 120 boot operating system and application software to the processing nodes 105 for use in implementing the Processing Area Networks. In the described embodiments, the processing nodes 105 also receive and instantiate an additional software component referred to herein as a Virtual Machine (VM) hypervisor, automatically when needed from the one or more control nodes 120. The Virtual Machine hypervisor implements the logic which divides a physical processing node into fractions, called Virtual Machines, within which “guest” operating systems and applications can run as if they had an entire processing node to themselves. The Virtual Machine hypervisor creates, manages, controls, and destroys Virtual Machine instances on a given processing node. In preferred embodiments, the Virtual Machine hypervisor is arranged as a thin software layer that is embedded between the processing node 105 hardware and the operating system software. The Virtual Machine hypervisor provides an abstraction layer that allows each physical processor 107 on the processing node 105 to run one or more Virtual Machines, thereby decoupling the operating system and any associated applications from the physical processor 107.

At least one of the preferred embodiments uses the Xen Virtual Machine hypervisor, provided by XenSource of Palo Alto, Calif. Xen is an open-source, feature-rich and efficient Virtual Machine hypervisor. Through its technique of “paravirtualization” (guest OS source modifications), it can support Virtual Machines with close to native performance. Xen 3.0 supports both uniprocessor and multiprocessor Virtual Machines and a live migration capability that allows guest operating systems and applications to move between hosts with minimal downtime (measured in milliseconds). But the invention is not restricted to Xen. There are many Virtual Machine hypervisors on the market, and the invention is capable of utilizing any of them. In fact, it is a benefit of the invention that the details of the employed hypervisor are embedded internally to the invention and hidden from users.

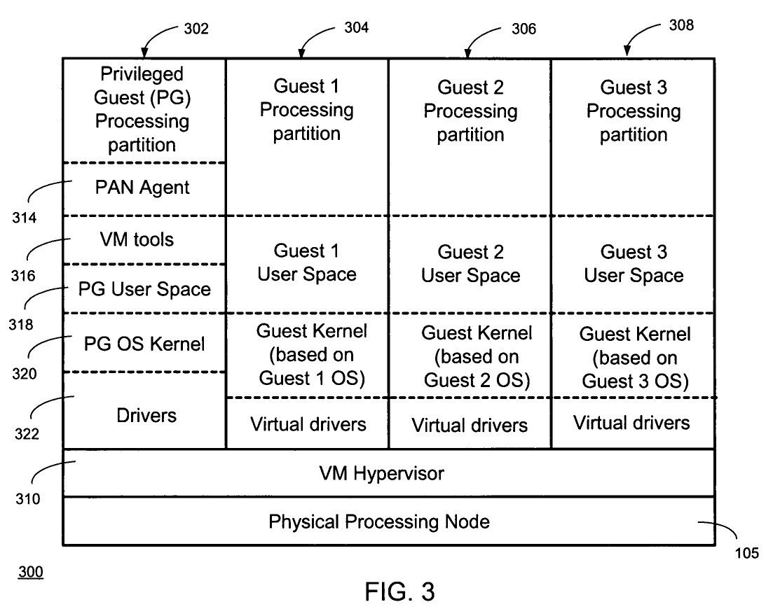

FIG. 3 shows Virtual Machines implemented on a physical processing node 105 according to one embodiment of the invention. This example shows four Virtual Machines 302, 304, 306 and 308 supported by a Virtual Machine hypervisor 310, and running on a physical processing node 105. The virtual machine instances are also referred to as “guests”. In this embodiment, the Virtual Machine hypervisor 310 is a Xen version 3.0 Virtual Machine hypervisor.

The first of the four Virtual Machines in this exemplary embodiment is the “Privileged Guest” (PG) 302. The Privileged Guest is the first Virtual Machine to be started, and provides management functions for the other guests 304, 306 and 308. The Privileged Guest 302 hosts Virtual Machine management tools 316, an operating system user space 318, an operating system kernel 320, and drivers 322 for communicating with the physical hardware 105. The Privileged Guest runs no user applications, but is dedicated to supporting the guests 304-306 that do. These components 316-322 are standard parts of Virtual Machine technology.

The Processing Area Network agent 314 is an application that runs in the Privileged Guest Virtual Machine 302 on top of the Privileged Guest operating system 318-320. The agent 314 is in communication with control logic on the one or more control nodes of the platform through the high-speed internal communication network shown in earlier figures. When control logic on the one or more control nodes determines that Virtual Machine technology needs to be configured, managed, or controlled, said logic sends messages containing Virtual Machine commands through the high-speed internal communication network to the Processing Area Network agent 314, which in turn relays them to the Virtual Machine hypervisor 310. It is in this manner that control logic running on the one or more control nodes is able to configure and administer the Virtual Machine technology on each processing node 105. Said configuration and administration can occur automatically, without the involvement of a human administrator. Also, as will be seen later, even deployment of the Virtual Machine technology to processing node 105 can be performed automatically by the platform's control logic, again without the involvement of a human administrator.

The Privileged Guest operating system kernel 320 requires software drivers 322 to interface it to the hardware 105 on which it runs. In certain embodiments, the drivers emulate Ethernet functionality over a point-to-point fabric; these drivers were described in the patents and patent applications incorporated by reference. The drivers 322 permit the operating system kernel 320 to correctly operate on the hardware 105 and to send and receive information over the high-speed internal communication network to which the processing node hardware 105 is connected. The drivers 322 also provide virtual disk, network, and console functions for the operating system kernel 320, functions which are not present physically in hardware 105. Disk, network, and console operations instantiated by the operating system kernel 320 are encapsulated in messages by the drivers 322 and sent over the high-speed internal communication network to the remote location where the actual physical disk, network, and console functions take place. The operating system kernel 320 thus behaves as if it were provided with local disk, network, and console functions, through the illusion provided by the drivers 322. This virtualization is a standard part of Processing Area Networking technology.

Similarly, the Virtual Machine hypervisor 310 intercepts the disk, network, and console functions of the guest Virtual Machines 304-308 which lack physical disk, network, and console functions, and instead executes these functions in the context of the Privileged Guest Virtual Machine 302, which it believes to have these functions. This is standard Virtual Machine technology. In the current invention, the Privileged Guest Virtual Machine 302 as well lacks actual physical disk, network, and console functions, but these functions are provided virtually by drivers 322. Thus, disk, network, and console operations which are instantiated in the guests 304-308 are first virtualized by the Virtual Machine hypervisor 310 and sent to the Privileged Guest 302 for execution, and then they are again virtualized by the drivers 322, after which they are sent over the high-speed internal communication network to the remote points where they are ultimately physically executed.

Each guest Virtual Machine 304-308 runs an instance of an operating system (OS), such as a server operating system, together with its application workload, each Virtual Machine running atop the Virtual Machine hypervisor. The operating system instance does not access the physical processor 105 directly, but instead accesses the physical processor 105 hardware through the Virtual Machine hypervisor. Through the Virtual Machine hypervisor, the operating system instance can share the physical processor hardware resources with other virtualized operating system instances and applications.

Each Virtual Machine running on the Virtual Machine hypervisor can be thought of as a partition of processing node 105, analogous in some ways to a partition of a disk. While a disk partition splits a physical disk drive into smaller independent logical disk units, a virtual machine splits a physical processing node 105 into independent logical compute units.

The platform or Processing Area Network administrator specifies the conceptual creation of Virtual Machines by entering configuration specifications for them to the platform control logic running on the one or more control nodes, and each specified Virtual Machine is associated with a particular processing node of the hardware platform. The configuration specification defines how many processors and how much memory the Virtual Machine emulates for the software that will run within it. While ordinarily with Virtual Machine technology a Virtual Machine specification would need to describe much more, in particular the network, disk, and console devices to be emulated by the Virtual Machine, these details are unnecessary in the current embodiments. Instead, those details are determined automatically from the virtual server definition at the time a virtual server is assigned to run on the Virtual Machine, as will be described below. That is to say, the network, disk, and console device configurations are considered to be properties of the virtual server definition, not of the hardware the server runs on, whether a physical processing node or a Virtual Machine. The configuration specifications of the various Virtual Machines are persisted as part of the Processing Area Network configuration, alongside the various virtual server definitions, for example, on the local disks of the one or more control nodes. (In certain embodiments, a Virtual Machine is not actually created on a processing node at the time an administrator creates a definition for it. The actual creation of the Virtual Machine is deferred, as will be described below.)

In the context of FIG. 1, once one or more of the plurality of processing nodes 105 have been specified to be divided up into guest Virtual Machines, the one of more control nodes 120 can regard both undivided (physical) processing nodes as well as the guest Virtual Machines on nodes fractioned by Virtual Machine technology equally as the plurality of resources on which to deploy virtual servers. That is, according to Processing Area Networking technology, just as a virtual server is a definition, abstracted away from any particular physical processor and capable of running on a variety of physical processors, the virtual server is equally capable of running as a guest on a fraction of a physical server allocated for it by a Virtual Machine hypervisor. Thus, with the benefit of this invention, virtual server definitions can, without any change or alteration to them, be instantiated on exactly the correct amount of processing resource, be it one or more physical processors or a small virtual fraction of a single processor.

The actual choice of on what resource to launch a virtual server definition can be made in a variety of ways, and the virtual server definition specifies how the choice will be made. The user can choose a specific resource. The user can specify a collection of resources that he has populated with resources of some given power or other preferred attribute. The user can specify desired attributes for his virtual server, so that control logic will select a resource of matching attributes, the attributes being such as the number of processors required, the amount of memory required, and the like. The choice could be made by control logic executing on the one or more control nodes that inspects the load or performance metrics observed on running virtual servers and uses that knowledge to launch future servers.

With this invention, it is easy to experiment with varying amounts of processing resource for any given virtual server, by successively launching the virtual server on alternative resources and seeing how it performs on each. Such experiments take only minutes to perform with this invention, but they might take weeks without it.

A Virtual Machine instance is not created on a physical processing node at the time the Virtual Machine's definition is created. Instead, the creation of the actual Virtual Machine is deferred until it is needed to run a virtual server or until an administrator chooses to manually boot it.

At the time a virtual server is booted, a choice is made as to what processing resource it will run on. This choice can be made in a variety of ways, as described above, some manual and some automatic. Regardless of how the choice is made, if a Virtual Machine is the chosen resource, control logic running on the one or more control nodes of the platform is aware of whether or not Virtual Machine hypervisor and Virtual Machine Privileged Guest are already running on the chosen physical processing node. If the Virtual Machine technology is already running, the control logic automatically and without human intervention instructs the Virtual Machine technology to create a guest Virtual Machine to run the virtual server, including instructing it to emulate the network, disk, and console devices of the virtual server definition, and then instructs the Virtual Machine to perform an operating system boot operation. Referring to FIG. 3, these instructions are done in the form of command messages sent from the control logic through the high-speed internal communication fabric to the Processing Area Networking agent 314 residing on the physical processing node 105 hosting the chosen Virtual Machine. The agent 314 relays those commands to its associated Privileged Guest operating system 318-320 and Virtual Machine hypervisor 310, which in turn causes the chosen Virtual Machine, say guest 306 for example, to configure the requested emulated devices and then to perform an operating system boot operation. Said operating system boot operation in guest 306 occurs in exactly the same manner as an operating system boot operation on a physical processing node, as has been previously described, with the one change that all the networking, disk, and console operations performed by the guest Virtual Machine 306 as it boots are virtualized twice instead of only once, first by the Virtual Machine technology embodied in the Virtual Machine hypervisor 310 and the Virtual Machine Privileged Guest operating system 318-320, and then second by the Processing Area Networking technology embodied in device drivers 322 in the Privileged Guest, again as has been previously described.

On the other hand, at the time a virtual server is to be booted onto a Virtual Machine, control logic may discover that no Virtual Machine technology is running on the chosen physical processing node. In this case, control logic must boot the Virtual Machine technology onto the processing node first before it can create a guest Virtual Machine to boot the virtual server as above. Control logic boots the Virtual Machine technology onto the processing node automatically and without human intervention by instructing the processing node to perform a network boot (as if it were network booting a normal virtual server) and supplying as the boot image a bootable image of the Virtual Machine technology. This boot image is stored on the local disks of the one or more control nodes, alongside other network boot images, so that it is available for this purpose. Referring again to FIG. 3, such an image would contain bootable copies of the Virtual Machine hypervisor logic 310 and all components of the Privileged Guest processing partition 302. When such an image is booted onto a processing node, the Virtual Machine hypervisor 310 is installed, the Privileged Guest operating system 318-320 is installed and initializes itself, including discovering how to use its device drivers 322 to exchange messages with control logic on the platform's one or more control nodes. Then the Processing Area Networking agent begins executing, and begins awaiting messages containing commands sent from the platform's control logic instructing the Virtual Machine technology what to do. At this point, the control logic can proceed to create a Virtual Machine and boot a virtual server onto it, as previously described.

The Privileged Guest operating system 318-320 normally incorporates a file system (not shown in FIG. 3) to store the configurations of the various guest Virtual Machines 304-308 it may run from time to time. When Virtual Machine technology is used on stand-alone computers, often this file system is hosted on local disks of those computers. As the preferred embodiments deploy Virtual Machine technology upon demand whenever needed, and no state is retained on a processing node in between executions, any file system required by the Privileged Guest operating system 316-318 is hosted in the memory of processing node 105, and it contents are discarded whenever the last guest Virtual Machine 304-308 concludes execution. Thus, no disk storage need be provided to processing node 105 for use of the Virtual Machine technology.

If Virtual Machine technology is found to be already running on the chosen processing node when a virtual server is to be booted, the server boots more quickly, as it does not have to wait for the Virtual Machine technology itself to boot first. Thus, in some embodiments, the platform allows the administrator, if he so chooses, to ask that the control logic boot a defined Virtual Machine immediately upon his request, rather than waiting for a virtual server boot to trigger it.

It should be noted that the mechanics of deploying, configuring, and operating the Virtual Machine technology are completely embedded within the platform, and that no user or administrator involvement is necessary to launch or administer the Virtual Machine technology. The platform automatically deploys, configures, and operates the Virtual Machine technology as needed. In fact, users may deploy virtual servers on various processor resources provided by the platform without any awareness as to whether those resources are physical or virtual, or without being aware even that Virtual Machine technology was being used inside the platform.

Some embodiments of Processing Area Networking technology provide failover service to their virtual servers. This normally works by allowing virtual server definitions to specify both a normal processing resource and a failover processing resource. Such resource specifications may take a variety of forms, as described above, such as a specific hardware node, a collection of resources, attributes of resources to be matched, or the like. The virtual server is first booted on its normal processing resource. Control logic located on the one or more control nodes constantly monitors the correct operation of the server, such as by exchanging messages with it. If the server crashes or becomes hung, the control logic will attempt to reboot it, first with the same processing resource. If the problem was some transient software error, this will get the server operational again. If the server again fails, perhaps there is a hardware error on the normal processing resource, and the control logic moves the virtual server to the failover processing resource. When Virtual Machine technology is added to a platform supporting failover, the virtual server definitions still allow both the normal and the failover processing resource to be specified. The only difference is that either or both of these resources can be Virtual Machines as well as physical processing nodes, or pools or attributes that include Virtual Machines as well as physical nodes. A virtual server running on any resource, be it an entire physical node or a Virtual Machine, is first rebooted on that same resource when it fails. If it fails again, it is rebooted on the failover resource, be it a physical node or a Virtual Machine.

Some embodiments may fail over Virtual Machines to a different physical processing node if the underlying physical processing node fails. Others may not. On an embodiment which does not, best practice is to avoid specifying two Virtual Machines hosted on the same physical processing node as the normal and failover processing resources for a given virtual server. This is because a failure of that one physical processing node would take down both of those Virtual Machines, and the virtual server would fail. Instead, Virtual Machines on two different processing nodes should be specified as the normal and the failover resources. That way, no single failure can prevent the execution of the virtual server.

Virtual Machine technology may offer functions that are unavailable on physical processing hardware. Three such functions typically provided are suspend and resume, migration of a suspended guest to another Virtual Machine, and migration of a running guest to another Virtual Machine, though there may be others. Preferred embodiments of the invention will allow these functions to be applied to a virtual server when it is running as a Virtual Machine guest. (Unfortunately, these functions cannot be supported for a virtual server when it is running alone on a physical processing node.)

To suspend means to stop the operation of a virtual server in the middle of its execution, but in such a way that the entire state of its execution is saved, so that its execution may be later resumed as if it had never been interrupted. When a virtual server is running as a Virtual Machine guest, control logic running on the one or more control nodes allows the user or administrator to ask that the server be suspended. Control logic sends messages containing suspend commands to the Processing Area Networking agent running on the server's processing node, which in turn relays them to its Privileged Guest operating system and Virtual Machine hypervisor. The Privileged Guest operating system and Virtual Machine hypervisor together implement the suspend function as is standard for Virtual Machine technology. The state of a suspended server includes the contents of its processor registers and the contents of its memory at the instant of its suspension. Typically, the register and memory state of a suspended server is written into a file on the file system of the Privileged Guest operating system kernel. But retaining such state there would associate such state with the processing node the server was running on rather than with the virtual server definition, which must be independent of any specific deployment. In the preferred embodiments, the suspended state data is instead read out of the Privileged Guest's file system by the Processing Area Networking agent on the processing node and sent in messages to control logic on the one or more control nodes, where it is written into a file on the persistent storage (e.g., local disks) of the one or more control nodes, alongside and associated with the respective virtual server definition.

At any subsequent time, a virtual server which had been suspended can be resumed. The resumed virtual server can be deployed on the same processing node from which it was suspended, or any other, because its saved state data has been retained persistently on the one or more control nodes. When a suspended virtual server is to be resumed, control logic on the one or more control blades instantiates a Virtual Machine on which to deploy it, in the same way Virtual Machines are created when necessary to boot any server. But instead of being told to boot the virtual server, the Virtual Machine is instructed to resume the previously saved state. This instruction is done by commands sent in messages from control logic on the one or more control nodes to the Processing Area Networking agent on the resuming processing node. The data of the saved state is also sent in such messages from where it was saved on the one or more control nodes to the said Processing Area Networking agent, which in turn relays it to the Virtual Machine technology performing the resume operation.

Some Virtual Machine technologies permit a running guest to be moved from one Virtual Machine to another. Conceptually this can be thought of as suspending the guest, moving its state, then resuming it. But in practice, the time it takes to move the state is perceptible, and the delay during the suspension may be detrimental to the functioning of the guest. Thus, moving a running guest is generally performed in a more complex fashion that minimizes the delay. The memory state is copied while the guest is running and still making changes to its memory. But the Virtual Machine technology has the ability to intercept and monitor all accesses to memory, so it keeps track of what portions of memory the guest changes during the copy. When the first copy completes, the guest can be suspended for a short amount of time while just the portions of its memory that changed during the first copy are transferred to the receiving Virtual Machine. Preferred embodiments of the current invention permit users or administrators to request migration of running virtual servers from one Virtual Machine to another. The control logic for moving a running virtual server is actually identical to that for moving a suspended one, as described above. All the complications of minimizing the delay while the state is copied are handled by the embedded Virtual Machine technology, just as if it were running on conventional computer hardware.

Another feature that Virtual Machine technology may offer is the ability to map a guest's virtualized disk onto a partition of a physical disk or onto a file in the Privileged Guest's file system. Thus, a small number of physical disks may support a large number of guests, provided the guests do not consume much space on their virtual disks. In the current invention this ability of Virtual Machine technology to map virtualized disks onto other than full physical disks is not used, so that the disks a virtual server is configured to access can follow it as it is launched from time to time on various processing nodes or various Virtual Machines.

A number of different Virtual Machine technologies are available in the industry, some popular ones being open-source Xen, EMC's VMware, and Microsoft's Virtual Server. Different Virtual Machine technologies, while providing a large set of features in common with each other, may offer unique features or other benefits, causing users to sometimes prefer one over another. Some embodiments of the invention support multiple Virtual Machine technologies simultaneously or multiple versions of the same Virtual Machine technology. In such embodiments, the Virtual Server definition stored on the one or more control nodes also specifies the chosen Virtual Machine technology and version. Network boot images for all possible Virtual Machine technologies are stored on the local disks of the one or more control blades, so that the correct image can be deployed to a processing node when launching a particular Virtual Machine. Control logic on the one or more control nodes and Processing Area Networking agents have the ability to formulate and process the detailed commands needed to manage each Virtual Machine technology version, should those commands differ.

In some embodiments, some of the Virtual Machine technology may be provided as hardware or firmware persistently resident on the platform's processing nodes, lessening the amount of such technology that need be downloaded to the processing nodes from the one or more control nodes. Such technology is nonetheless used as above to instantiate as needed the Virtual Machines on which to boot virtual servers, and it is nonetheless configured and managed by commands sent from control logic on the one or more control nodes to Processing Area Networking agents located on the respective processing nodes.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

What is claimed is:

1. A computing platform for automatically deploying one or more servers in response to receiving corresponding server specifications, each server specification identifying a server application that a corresponding server should execute and defining communication network and storage network connectivity for the server, the platform comprising:
a plurality of processor nodes each including at least one computer processor and physical memory;
virtual machine hypervisor logic installable and executable on a set of the processor nodes, the virtual machine hypervisor logic having logic for instantiating and controlling the execution of one or more guest virtual machines on a computer processor, each guest virtual machine having an allocation of physical memory and of processing resources;
control software executing on a processor for interpreting a server specification and for, in response to interpreting the server specification,
deploying computer processors or guest virtual machines to execute the identified server application and
automatically configuring the defined communication network and storage network connectivity to the selected computer processors or guest virtual machines to thereby deploy the server defined in the server specification.

2. The platform of claim 1 wherein the control software includes software to automatically install and cause the execution of virtual machine hypervisor logic on a processor node in response to interpreting a server specification and selecting a guest virtual machine to satisfy requirements of the server specification.

3. The platform of claim 1 wherein a server specification specifies a pool corresponding to designated processing nodes or guest virtual machines, and wherein said control software includes logic to select processing nodes or guest virtual machines from the specified pool to satisfy requirements of the server specification.

4. The platform of claim 1 wherein the virtual machine hypervisor logic is Xen hypervisor software.

5. The platform of claim 1 wherein the server specification is independent of the virtual machine hypervisor logic.

6. The platform of claim 1 wherein the platform includes multiple versions of virtual machine hypervisor logic, and wherein the control software can cause the installation and simultaneous execution of a plurality of different versions of the virtual machine hypervisor logic to satisfy a plurality of server specifications.

7. The platform of claim 1 wherein the control software includes logic to migrate the deployment of a server from a first set of computer processors or guest virtual machines to a second set of computer processors or guest virtual machines.

8. The platform of claim 1 wherein the processor nodes are connected to an internal communication fabric, and wherein automatically configuring the defined communication network includes configuring the internal communication fabric to emulate a defined Ethernet connectivity, and wherein the processor nodes are provisioned to include communication network drivers to emulate Ethernet functionality on the internal communication fabric.

9. The platform of claim 1 wherein servers deployed on the platform are suspendable, and wherein the control software includes logic to retain execution states of suspended servers on persisted storage separate from any instance of virtual machine hypervisor logic, so that such suspended states may be resumed by other instances of virtual machine hypervisor logic.

10. The platform of claim 9 wherein the persisted storage is a local disk associated with the control software.

11. The platform of claim 1 wherein the server specification is a computer-readable document of pre-defined syntax.

12. A method for automatically deploying one or more servers in response to receiving corresponding server specifications, each server specification identifying a server application that a corresponding server should execute and defining communication network and storage network connectivity for the server, the method comprising:
providing a plurality of processor nodes each including at least one computer processor and physical memory;
providing virtual machine hypervisor logic installable and executable on a set of the processor nodes, the virtual machine hypervisor logic having logic for instantiating and controlling the execution of one or more guest virtual machines on a computer processor, each guest virtual machine having an allocation of physical memory and of processing resources;
control software, executing on a processor, interpreting a server specification and, in response to interpreting the server specification,
deploying computer processors or guest virtual machines to execute the identified server application and
automatically configuring the defined communication network and storage network connectivity to the selected computer processors or guest virtual machines to thereby deploy the server defined in the server specification.

13. The method of claim 12 wherein the control software automatically installs and causes the execution of virtual machine hypervisor logic on a processor node in response to interpreting a server specification and selects a guest virtual machine to satisfy requirements of the server specification.

14. The method of claim 12 wherein a server specification specifies a pool corresponding to designated processing nodes or guest virtual machines, and wherein said control software selects processing nodes or guest virtual machines from the specified pool to satisfy requirements of the server specification.

15. The method of claim 12 wherein the platform includes multiple versions of virtual machine hypervisor logic, and wherein the control software causes the installation and simultaneous execution of a plurality of different versions of the virtual machine hypervisor logic to satisfy a plurality of server specifications.

16. The method of claim 12 wherein the control software migrates the deployment of a server from a first set of computer processors or guest virtual machines to a second set of computer processors or guest virtual machines.

17. The method of claim 12 wherein the processor nodes are connected to an internal communication fabric, and wherein automatically configuring the defined communication network includes configuring the internal communication fabric to emulate a defined Ethernet connectivity, and wherein the processor nodes are provisioned to include communication network drivers to emulate Ethernet functionality on the internal communication fabric.

18. The method of claim 12 wherein servers deployed on the platform are suspendable, and wherein the control software retains execution states of suspended servers on persisted storage separate from any instance of virtual machine hypervisor logic, so that such suspended states may be resumed by other instances of virtual machine hypervisor logic.

19. The method of claim 18 wherein the persisted storage is a local disk associated with the control software.

20. A computer program product for automatically deploying one or more servers on a computing platform in response to receiving corresponding server specifications, each server specification identifying a server application that a corresponding server should execute and defining communication network and storage network connectivity for the server, the platform having a plurality of processor nodes each including at least one computer processor and physical memory, the computer program product including computer executable instructions encoded on a computer readable medium including:
computer executable instructions for providing virtual machine hypervisor logic, said virtual machine hypervisor logic having logic for instantiating and controlling the execution of one or more guest virtual machines on a computer processor, each guest virtual machine having an allocation of physical memory and of processing resources;
computer executable control instructions for interpreting a server specification and for, in response to interpreting the server specification,
deploying computer processors or guest virtual machines to execute the identified server application and
automatically configuring the defined communication network and storage network connectivity to the selected computer processors or guest virtual machines to thereby deploy the server defined in the server specification.

21. The computer program product of claim 20 wherein the computer executable control instructions includes computer executable instructions to automatically install and cause the execution of virtual machine hypervisor logic on a processor node in response to interpreting a server specification and selecting a guest virtual machine to satisfy requirements of the server specification.

22. The computer program product of claim 20 wherein a server specification specifies a pool corresponding to designated processing nodes or guest virtual machines, and wherein said computer executable control instructions includes logic to select processing nodes or guest virtual machines from the specified pool to satisfy requirements of the server specification.

23. The computer program product of claim 20 wherein the computer executable instructions for providing virtual machine hypervisor logic provides multiple versions of virtual machine hypervisor logic, and wherein the computer executable control instructions can cause the installation and simultaneous execution of a plurality of different versions of the virtual machine hypervisor logic to satisfy a plurality of server specifications.

24. The computer program product of claim 20 wherein the computer executable control instructions includes instructions to migrate the deployment of a server from a first set of computer processors or guest virtual machines to a second set of computer processors or guest virtual machines.

25. The computer program product of claim 20 wherein servers deployed on the platform are suspendable, and wherein the computer executable control instructions includes instructions to retain execution states of suspended servers on persisted storage separate from any instance of virtual machine hypervisor logic, so that such suspended states may be resumed by other instances of virtual machine hypervisor logic.
